(19) United States
(12) Patent Application Publication
(10) Pub. No.: US 2009/0119901 A1
(43) Pub. Date: May 14, 2009

(54) FOAM SKIN INSULATION WITH SUPPORT MEMBERS

(75) Inventor: Rob Wessels, Hickory, NC (US)

Correspondence Address: Muncy, Geissler, Olds & Lowe, PLLC, P.O. BOX 1364, FAIRFAX, VA, 22038-1364, US

(73) Assignee: CommScope, Inc. of North Carolina

(21) Appl. No.: 11/939,169

(22) Filed: Nov. 13, 2007

(51) Int. Cl. B23P 15/00; B23P 19/04

(52) U.S. Cl. 29/592.1; 29/428

(57) ABSTRACT

A wire includes a conductor. A foam insulation surrounds an outer surface of the conductor. A jacket surrounds the foam insulation and presents a plurality of projections on an inner surface thereof, which extend toward the conductor, yet do not purposefully contact the conductor. With the foam insulation having a lower dielectric constant than the jacket material, the electrical performance of the wire is improved, while maintaining a good crush resistance.

### BACKGROUND OF THE INVENTION

1. Field of the Invention

The present invention relates to a wire. More particularly, the present invention relates to a wire with improved insulation for better performance in a twisted pair cable.

2. Description of the Related Art

As illustrated in FIGS. 1 and 2, a wire 100 for use with a twisted pair cable is well known in the industry. The typical wire 100 has a centrally located conductor 101 formed of solid or stranded copper. A protective layer 103 completely surrounds the conductor 101. The protective layer 103 is formed of a durable and nonconductive polymer and prevents the conductor 101 from making electrical contact with other conductive structures except at termination points (e.g. at an insulation displacement (IDC) connector).

The protective outer layer 103 has been known to present drawbacks for the wire 100. First, the outer protective layer 103 must be formed of a relatively solid polymer in order to be durable (e.g., not easily torn off of the conductor 101 with abrasion), and in order to receive pigments or inks for identification purposes during installation 105

Unfortunately, relatively solid polymers have a somewhat high dielectric constant (e.g., 2.0 or greater), which can hinder the electrical performance of the wire (e.g. increases signal attenuation, which leads to signal distortion and delay).

One solution to the drawbacks of the prior art illustrated in FIGS. 1 and 2 is illustrated in the prior art of FIGS. 3 and 4. In FIGS. 3 and 4, an improved wire 110 includes an inner conductor 111 surrounded by a foamed insulation layer 113. The foamed insulation layer 113 is surrounded by a protective layer 115, which is constructed of a solid polymer (like the element 103 of FIGS. 1-2).

The foamed insulation layer 113 has a lower dielectric constant as compared to the protective layer 115. The lower dielectric constant of the foamed insulation layer 113 is due to the inclusion of closed-cell air pockets in the material (e.g., polymer) constituting the foamed insulation layer. Air has a dielectric constant of approximately 1.0. Therefore, the overall dielectric constant of the foamed insulation layer 113 could be made to about 1.7 by including air in a foamed polymer material at about 30% per volume.

Finally, the protective layer 115 is provided to surround the foamed insulation layer 113. The protective layer 115 is typically included because the foam insulation layer 113 ordinarily is not durable and may tear off of the conductor 111 with abrasion. Moreover, the foamed insulation layer 113 is typically not well suited for receiving pigments or inks for identification 117.

Another solution to the drawbacks of the prior art illustrated in FIGS. 1 and 2 is illustrated in the prior art of FIGS. 5 and 6, as seen in U.S. Pat. No. 7,238,886, which is herein incorporated by reference. In FIGS. 5 and 6, an improved wire 120 includes an inner conductor 121 surrounded by a protective layer 123. The material used to form the protective layer 123 is durable and may be the same material used for the protective layers 103 and 115 of FIG. 1-4, which generally has a dielectric constant of at least about 2.0.

In order to improve the overall dielectric constant of the protective layer 123, elongated air channels 125 are formed within the protective layer 123. The elongated air channels 125 communicate to an outer surface of the conductor 121. Thereby, in a cross sectional view, the outer surface of the conductor 121 is exposed to a sequential series of protective layer material constituting projections 127 and air within channels 125, as best seen in FIG. 6. In the example of FIG. 6, the outer surface of the conductor 121 is exposed to six projections 127 formed of the protective layer material and six channels 125 of air.

### SUMMARY OF THE INVENTION

Applicant has appreciated one or more drawbacks associated with the prior art of FIGS. 1-6. With the prior art embodiment of FIGS. 1-2, the outer protective layer 103, which is formed of a relatively solid polymer having a somewhat high dielectric constant (e.g., 2.0 or greater), directly contacts most or all of the entire outer surface of the conductor 101. This can lead to drawbacks in that the electrical performance of the wire 100 is inferior. In other words, a material with a high dielectric constant is directly contacting the outer surface of the conductor 101, where electrical signals travel, which can increase signal attenuation, leading to signal distortion and delay.

With the prior art embodiment of FIGS. 3-4, a foam insulation layer 113 surrounds and contacts the outer surface of the conductor 111. The foam insulation layer 113 has a relatively lower dielectric constant as compared to an outer protective layer 115. Therefore, the electrical performance of the wire 110 is enhanced relative to the wire 100. However, when the wire 110 is spooled prior to assembling a twisted pair cable, and when the wire 110 is twisted with another wire during the assembly of a twisted pair cable, the foam insulation layer 113 tends to compress, which may give the wire 110 an overall oval shape. This is accentuated by the tight twists found in Category 6 or 6A type cable designs. Compression of the foam insulation layer 113 changes the dielectric constant of the compressed portions adjacent to the outer surface of the conductor 111 by elimination of the closed-cell air pockets within those portions of the foam insulation layer 113. Hence, the electrical performance of the wire 110 may be degraded.

With the prior art embodiment of FIGS. 5-6, a series of air channels 125 (having a dielectric constant of about 1.0) and material forming the protective layer 123 (having a dielectric constant of generally greater than 2.0) surround the conductor 121. Therefore, an average value of the dielectric constant immediately adjacent to the outer surface of the conductor 121 can be reduced relative to the prior art wire 100 of FIG. 1-2, which improves the electrical performance of the wire 120. Applicant has appreciated that, during a typical manufacturing process of the wire 120, the extruded jacket material tends to expand and flow. With open air channels 125 adjacent to the projections 127, the hot tips of the projections 127 contacting the conductor 121 might tend to flow along the outer surface of the conductor 121 to form expanded tip portions. Therefore, the high dielectric material of the protective layer 123 can tend to be the material mostly in immediate contact with the outer surface of the conductor 121, where electrical signals primarily flow. Also, the projections 127 touch the outer surface of the conductor 121, which can create a series of areas with high dielectric constants (projections 127) and low dielectric constants (air channels 125) in contact with the outer surface of the conductor 121. As currents primarily flow on the outer surface of the conductor 121, this encountered variation in dielectric constant might be detrimental to the electrical performance of the wire 120. Also, the projections 127 can deform under compressive forces reducing the volume of the air pockets further increasing the dielectric constant of the insulation layer.

It is an object of the present invention to provide a wire with improved electrical performance, as compared to existing wires, and/or to address one or more of the drawbacks of the prior art wires 100, 110 and 120.

These and other objects are accomplished by a wire including a conductor. A foam insulation surrounds an outer surface of the conductor. A jacket surrounds the foam insulation and presents a plurality of projections on an inner surface thereof, which extend toward the conductor, yet do not purposefully contact the conductor. With the foam insulation having a lower dielectric constant than the jacket material, the electrical performance of the wire can be improved, while maintaining a good crush resistance.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view of a cut end of a wire, in accordance with a first embodiment of the prior art;

FIG. 2 is a cross sectional view taken along line II-II of FIG. 1;

FIG. 3 is a perspective view of a cut end of a wire, in accordance with a second embodiment of the prior art;

FIG. 4 is a cross sectional view taken along line IV-IV of FIG. 3;

FIG. 5 is a perspective view of a cut end of a wire, in accordance with a third embodiment of the prior art;

FIG. 6 is a cross sectional view taken along line VI-VI of FIG. 5;

FIG. 7 is a perspective view of a cut end of a wire, in accordance with the present invention;

FIG. 8 is a cross sectional view taken along line VIII-VIII of FIG. 7;

FIG. 9 is a cross sectional view similar to FIG. 8, but illustrating a first alternative embodiment of the present invention; and

FIG. 10 is a cross sectional view similar to FIG. 8, but illustrating a second alternative embodiment of the present invention.

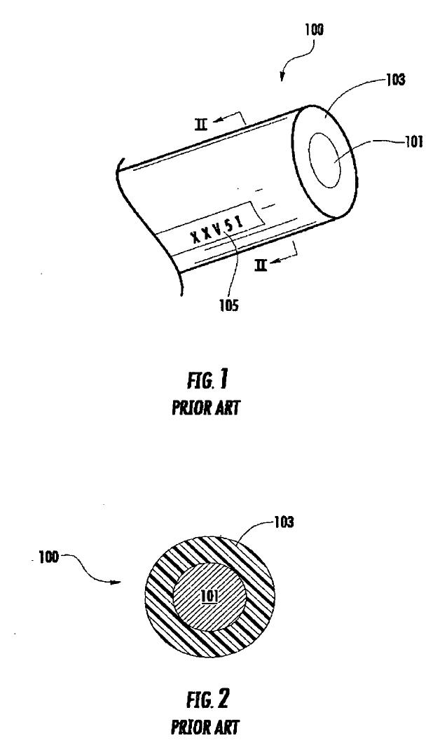

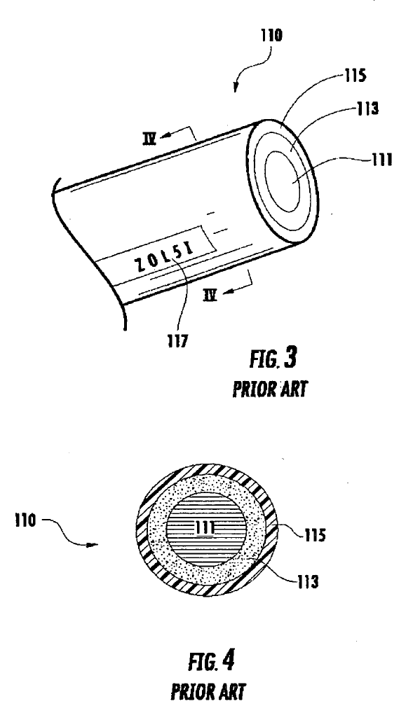

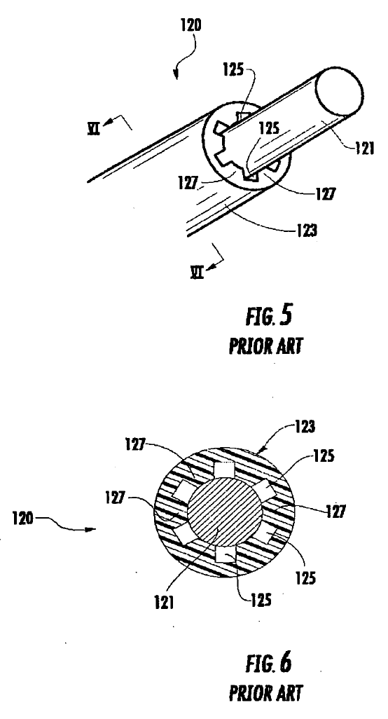

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

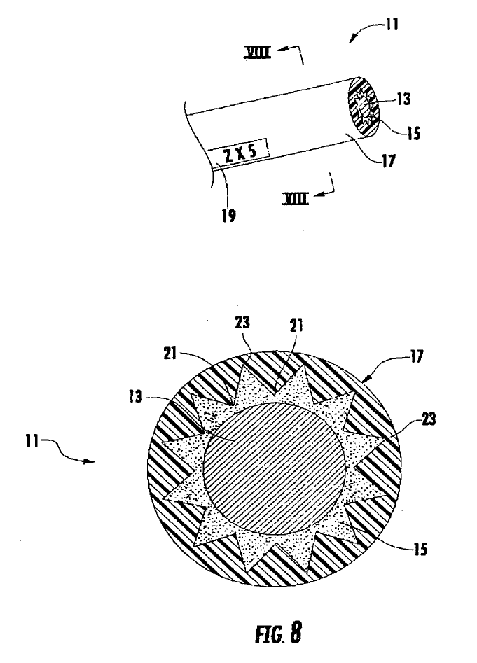

FIGS. 7 and 8 illustrate a wire 11, in accordance with the present invention. The wire 11 may be used to form a twisted pair cable. The wire 11 has a centrally located conductor 13, which may be formed of solid or stranded copper or other conductive materials.

A foam insulation 15 at least partially surrounds, and preferably completely surrounds, an outer surface of the conductor 13. The foam insulation 15 may be formed of a material having a dielectric constant in the range of about 1.4 to about 1.8. For example, the foam insulation 15 may be formed of foamed polyethylene, which includes at least 15% closed cell air pockets by volume, such as about 20% to about 40% closed cell air pockets by volume. In one embodiment, the closed cell air pockets occupy about 25% to about 30% of the volume of the foam insulation 15.

A jacket 17 at least partially surrounds, and preferably completely surrounds the foam insulation 15. The jacket may be formed of a durable material having a dielectric constant of at least 2.0. The durable material of the jacket 17 is well suited to protect the wire 11 from abrasion and to receive printed indicia 19. For example, the jacket 17 may be formed of a material or blend of materials selected from the group consisting of: polypropylene, polyethylene, Fluorinated Ethylene Propylene (FEP), PerFluoroAlkoxy (PFA) FEP and MethylFluoroAlkoxy (MFA) FEP. In a preferred embodiment, the dielectric constant of the material forming the foam insulation 15 is at least 20% lower than the dielectric constant of the material forming the jacket 17, and more preferably at least 30% lower.

A best seen in the cross sectional view of FIG. 8, the jacket 17 includes a plurality of projections 21 on its inner surface, which extend toward the conductor 13, without physically contacting the conductor 13. Therefore, the material with the high dielectric constant forming the jacket 17 does not contact the current carrying surface of the conductor 13 in FIG. 8.

In the embodiment of FIG. 8, the projections 21 have substantially triangular shapes, with sharp peaks of the triangular shapes facing toward the conductor 13. Also, the projections 21 may be adjacently spaced so as to create a series of sharp valleys 23 facing away from the conductor 13 between the adjacent peaks of the projections 21.

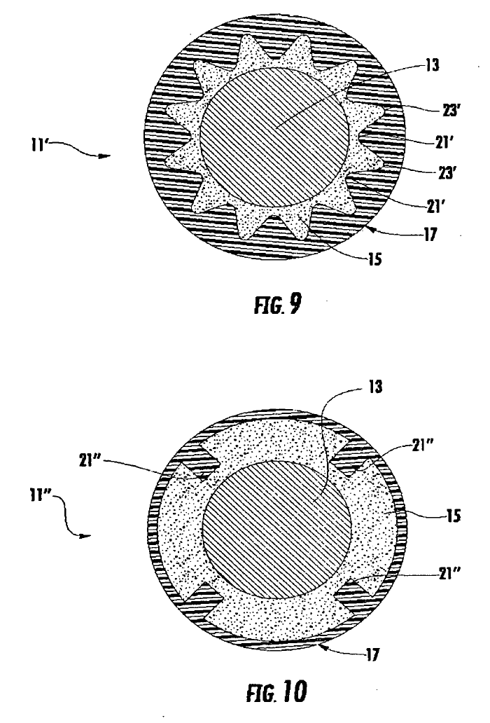

However, it is to be understood that the projections 21 may have other shapes while still enjoying the benefits of the present invention. For example, as illustrated in FIG. 9, a wire 11′ may have projections 21′ with slightly rounded features, so as to create a series of rounded peaks facing to the conductor 13 with rounded valleys 23′ disposed between adjacent rounded peaks. Alternatively, as illustrated in FIG. 10, a wire 11″ may have projections 21″ with substantially rectangular shapes, so as to create a series of block-shaped structures facing to the conductor 13, but not contacting the outer surface of the conductor 13.

In some embodiments, the plurality of projections 21 or 21′ includes at least ten projections 21 or 21′ formed on the inner surface of the jacket 17. For example, twelve projections 21 or 21′ may be formed on the inner surface of the jacket 17, as illustrated in FIGS. 8 and 9. However, it should be appreciated that more or fewer projections may be formed on the inner surface of the jacket 17, such as four projections 21″, as illustrated in FIG. 10. Although the pluralities of projections 21, 21′ and 21″ have been illustrated as being equally spaced from one another around the inner surface of the jacket 17, it should be understood that equal spacing is not critical.

As to dimensions, one embodiment of the present invention has an overall diameter of the wire being about 0.0390 to about 0.0430 inches with a conductor having a diameter of about 0.0232 to about 0.0238 inches. In one embodiment, the ends of the projections 21, 21′ or 21″, closest to the conductor 13, are spaced from the outer surface of the conductor 13 by at least 0.0010 inches, and perhaps spaced by a distance in the range of about 0.0015 inches to about 0.0040 inches.

In one embodiment of a manufacturing process, the conductor 13 is fed from a spool into a work station of a wire forming machine. In the work station, a heated polymer is extruded around the conductor 13 through a shaped die to form the jacket 17 with projections 21, 21′ or 21″, while a material to form the foamed insulation 15 is injected between the conductor 13 and jacket 17.

The presence of the foam insulation 17 inside of the jacket 17 assists in holding the shape of the internal projections 21, 21′ or 21″ during the manufacturing process while the projections 21, 21′ and 21″ cool and solidify via air and/or water bath, thereby reducing the likelihood that the shapes of the projections 21, 21′ or 21″ will become indistinct and deformed and/or contact the conductor 13.

In the resulting wire 11, 11′ or 11″, the outer surface eddy currents on the conductor 13 are presented with an immediately surrounding material having a low and much more uniform dielectric constant. The dielectric constant may vary somewhat due to the presence of the projections 21, 21′ or 21″ which approach the surface of the conductor; however, the influence of the higher dielectric material of the projections 21, 21′ or 21″ is reduced as a function of the spacing distance squared. Yet, the projections 21, 21′ or 21″ will still provide assistance in increasing the crush resistance of the wire 11, 11′ or 11″ as compared to the wire 110. If the wire 11, 11′, 11″ becomes compressed or crushed during use, a few of the projections 21, 21′, 21″ may become closer to the conductor 13, or even pierce the foam insulation 15 to contact the conductor 13 dependent upon the shape of the projections and force applied to the wire 11, 11′ or 11″. However, the embodiments of the present invention will typically continue to exhibit improved performance, as not all of the projections 21, 21′ or 21″ will be compressed toward the conductor 13, hence possibly realizing improved performance over the instance where all of the projections purposefully contact the conductor of the wire 120.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A wire comprising:
a conductor;
a foam insulation completely surrounding an outer surface of said conductor;
a jacket at least partially surrounding said foam insulation, wherein said jacket includes a plurality of projections on an inner surface thereof, which extend toward said conductor.

2. The wire according to claim 1, wherein ends of said projections closest to said conductor are spaced from said conductor by at least 0.0010 inches.

3. The wire according to claim 2, wherein ends of said projections closest to said conductor are spaced from said conductor by a distance in the range of about 0.0015 inches to about 0.0040 inches.

4. The wire according to claim 1, wherein said jacket is formed of a material having a dielectric constant of at least 2.0.

5. The wire according to claim 1, wherein said jacket is formed of a material or blend of materials selected from the group consisting of:
polypropylene, polyethylene, Fluorinated Ethylene Propylene (FEP), PerFluoroAlkoxy (PFA) FEP and MethylFluoroAlkoxy (MFA) FEP.

6. The wire according to claim 1, wherein said foam insulation is formed of a material having a dielectric constant in the range of about 1.4 to about 1.8.

7. The wire according to claim 1, wherein said foam insulation is formed of foamed polyethylene.

8. The wire according to claim 1, wherein said foam insulation includes at least 15% by volume of air.

9. The wire according to claim 1, wherein a dielectric constant of a material forming said foam insulation is at least 20% lower than a dielectric constant of a material forming said jacket.

10. The wire according to claim 1, wherein a diameter of said wire is about 0.0390 to about 0.0430 inches.

11. The wire according to claim 1, wherein said conductor is solid copper.

12. The wire according to claim 1, wherein a diameter of said conductor is about 0.0230 to about 0.0238 inches.

13. The wire according to claim 1, wherein said projections have substantially triangular shapes, with peaks of said triangular shapes facing toward said conductor.

14. The wire according to claim 1, wherein said projections form a series of sharp peaks facing toward said conductor and sharp valleys facing away from said conductor.

15. The wire according to claim 1, wherein said projections have substantially rectangular shapes.

16. The wire according to claim 1, wherein said plurality of projections includes at least ten projections formed on said inner surface of said jacket.

17. The wire according to claim 1, wherein said projections are equally spaced from one another around said inner surface of said jacket.

18. A wire comprising:
a conductor;
a foam insulation at least partially surrounding an outer surface of said conductor;
a jacket at least partially surrounding said foam insulation, wherein said jacket includes a plurality of projections on an inner surface thereof, which extend toward said conductor without physically contacting said conductor.

19. The wire according to claim 18, wherein ends of said projections closest to said conductor are spaced from said conductor by at least 0.0010 inches.

20. The wire according to claim 18, wherein said jacket is formed of a material having a dielectric constant of at least 2.0.

21. The wire according to claim 20, wherein said foam insulation is formed of a material having a dielectric constant in the range of about 1.4 to about 1.8.

22. The wire according to claim 18, wherein said foam insulation includes at least 15% by volume of air.

23. The wire according to claim 18, wherein a dielectric constant of a material forming said foam insulation is at least 20% lower than a dielectric constant of a material forming said jacket.

24. A method of manufacturing wire comprising:
feeding a conductor through a work station;
extruding a polymer through a shaped die to form a jacket surrounding the conductor, wherein the jacket includes projections on an inner surface which extend toward but do not contact the conductor; and
inserting a foam insulation between the jacket and the conductor.

25. The method according to claim 24, wherein said inserting step includes filling all portions of the space between the jacket and the conductor with foam insulation during said extruding step.
